(19) United States
(12) Patent Application Publication
(10) Pub. No.: US 2025/0070151 A1
(43) Pub. Date: Feb. 27, 2025

(54) CATHOD ACTIVE MATERIAL FOR ALL-SOLID-STATE BATTERY, CATHODE, AND ALL-SOLID-STATE BATTERY

(71) Applicants: POSCO Holdings Inc., Seoul (KR); RESEARCH INSTITUTE OF INDUSTRIAL SCIENCE & TECHNOLOGY, Pohang-si, Gyeongsangbuk-do (KR)

(72) Inventors: Yooncheol PARK, Busan (KR); Ji Woong MOON, Pohang-si (KR); Tai Hee EUN, Pohang-si (KR); Young Sang KIM, Pohang-si (KR); Jeongsik YUN, Busan (KR); Sang Cheol NAM, Seoul (KR)

(73) Assignees: POSCO Holdings Inc., Seoul (KR); RESEARCH INSTITUTE OF INDUSTRIAL SCIENCE & TECHNOLOGY, Pohang-si, Gyeongsangbuk-do (KR)

(21) Appl. No.: 18/720,912

(22) PCT Filed: Dec. 15, 2022
(86) PCT No.: PCT/KR2022/095153

§ 371 Date: Jun. 17, 2024

(30) Foreign Application Priority Data
Dec. 15, 2021 (KR) 10-2021-0180022

(51) Int. Cl. H01M 4/525; H01M 4/36; H01M 4/62; H01M 10/0562; H01M 10/42

(52) U.S. Cl. CPC H01M 4/525; H01M 4/366; H01M 4/628; H01M 10/0562; H01M 10/4235; H01M 2300/0068

(57) ABSTRACT

It is related to a positive active material for all solid batteries, comprising: a positive active material with layered crystal structure, and wherein, a XRD spectrum of a grain of the positive active material has diffraction peaks corresponding to the (003) plane and the (110) plane, and a ratio of the full width at half maximum (FWHM) of the diffraction peak corresponding to the (110) plane to the full width at half maximum (FWHM) of the diffraction peak corresponding to the (003) plane is 1.30 to 1.60.

### FIELD OF THE INVENTION

It is related to a positive active material for all solid batteries, a positive electrode and all solid battery.

### DESCRIPTION OF THE RELATED ART

Recently, there is a growing demand for increased driving range and improved safety of electric vehicles. Accordingly, the development of lithium secondary batteries with high weight and volume energy density while ensuring safety is important.

The energy capacity applied to particularly electric vehicles is in the tens of kwh level, so there is a high possibility of a large-scale sinter or explosion if the battery is damaged. Therefore, it is urgent to supplement the prior lithium secondary battery. Accordingly, all solid batteries that replace liquid electrolytes with solid electrolytes in lithium secondary batteries are being researched.

### SUMMARY OF THE INVENTION

One embodiment provides a positive active material for an all solid battery that can improve the performance of the all solid battery.

Another embodiment provides a positive electrode containing a positive active material for the all solid battery.

Another implementation provides an all solid battery including the positive electrode.

According to one embodiment, it is provided a positive active material for all solid batteries, comprising:

a positive active material with layered crystal structure, and wherein, a XRD spectrum of a grain of the positive active material has diffraction peaks corresponding to the (003) plane and the (110) plane, and a ratio of the full width at half maximum (FWHM) of the diffraction peak corresponding to the (110) plane to the full width at half maximum (FWHM) of the diffraction peak corresponding to the (003) plane is 1.30 to 1.60.

The full width at half maximum (FWHM) of the diffraction peak corresponding to the (003) plane may be 0.100 to 0.125.

The positive active material may be a secondary particle formed by agglomeration of primary particles, and the average particle diameter D50 of the secondary particle may be 3 μm to 12 μm.

The average grain size of the positive active material may be 70 nm to 90 nm.

The positive active material may include nickel (Ni) and cobalt (Co).

The positive active material may include layered nickel-cobalt-manganese-based oxide or layered nickel-cobalt-aluminum-based oxide.

The positive active material may include a coating layer containing LiZrO₃ or LiNbO₃.

The LiZrO₃ or LiNbO₃ may be included at 0.1 to 1.5 wt % relative to the positive active material.

According to another embodiment, a positive electrode including the above positive active material for an all solid battery is provided.

The positive electrode may further contain a sulfide solid electrolyte.

According to another embodiment, an all solid battery including the above positive electrode is provided.

The all solid battery may further include a negative electrode and a sulfide solid electrolyte.

By controlling the crystalline of the positive active material for an all solid battery, the performance of an all solid battery can be improved.

### BRIEF DESCRIPTION OF THE DRAWINGS

FIGS. 1 to 4 are SEM pictures of positive active material according to Preparation Example 1 to 4.

### DETAILED DESCRIPTION OF THE EMBODIMENTS

The terms such as first, second, and third are used to describe various portions, components, regions, layers, and/or sections, but various parts, components, regions, layers, and/or sections are not limited to these terms. These terms are only used to distinguish one part, component, region, layer, or section from another part, component, region, layer, or section. Accordingly, a first part, component, region, layer, or section described below may be referred to as a second part, component, region, layer, or section without departing from the scope of the present invention.

Terminologies as used herein are to mention only a specific exemplary embodiment, and are not to limit the present invention. Singular forms used herein include plural forms as long as phrases do not clearly indicate an opposite meaning. The term “including/comprising/containing/having” as used herein concretely indicates specific characteristics, regions, integer numbers, steps, operations, elements, and/or components, and is not to exclude presence or addition of other specific characteristics, regions, integer numbers, steps, operations, elements, and/or components.

When any portion is referred to as being “above” or “on” another portion, any portion may be directly above or on another portion or be above or on another portion with the other portion interposed therebetween. In contrast, when any portion is referred to as being “directly on” another portion, the other portion is not interposed between any portion and another portion.

Unless defined otherwise, all terms including technical terms and scientific terms as used herein have the same meaning as the meaning generally understood by a person of an ordinary skill in the art to which the present invention pertains. Terms defined in a generally used dictionary are additionally interpreted as having the meaning matched to the related art d° Cument and the currently disclosed contents and are not interpreted as ideal or formal meaning unless defined.

Hereinafter, a positive active material for an all solid battery according to an embodiment will be described.

The positive active material for an all solid battery according to one embodiment includes a positive active material of a layered crystal structure.

The positive active material of the layered crystal structure may include lithium transition metal oxides, including nickel (Ni) and cobalt (Co), and may be expressed as the following formula 1.

LiₐNiₓCo_{y}M1_{z}M2ₖO₂ [Chemical Formula 1]

In formula 1 above,
M1 may be Mn, Al or a combination thereof,
M2 is a metal or semi-metal excluding Ni, Co, Mn and Al, for example Zr, W, Mg, Ba, Ca, Ti, Ta, Nb, Mo, Si, V or a combination thereof,
it may be 0.9≤a≤1.5, 0.5<x≤0.95, 0<y≤0.4, 0<z≤0.4, and 0≤k≤0.02.

For example, the positive active material may include layered nickel-cobalt-manganese-based oxide or layered nickel-cobalt-aluminum-based oxide.

The positive active material may exist as secondary particles formed by agglomeration of primary particles with particle diameters of tens to hundreds of nanometers, and the average particle diameter D50 of the secondary particles may be about 3 μm to 12 μm. It may be about 3 μm to 10 μm or about 3 μm to 8 μm within the range.

The positive active material may include a coating layer positioned on the lithium transition metal oxide surface. The coating layer may contain a lithium metal oxide that is different from the lithium transition metal oxide described above, and may include LiZrO₃ or LiNbO₃, for example. LiZrO₃ or LiNbO₃ may be included at about 0.1 to 1.5 wt % relative to the positive active material, and may be included at about 0.5 to 1.5 wt % within the range. By being included in the range, the reaction with all solid electrolytes can be effectively suppressed in the interface with all solid electrolytes, which will be described later.

The positive active material may include a plurality of grains, and the plurality of grains may have an average grain size of sub-microns. For example, the average grain size of plurality of grains may be about 200 nm or less or about 100 nm or less, and within the range, it may be about 30 nm to 200 nm, about 30 nm to 100 nm, about 30 nm to 90 nm, about 50 nm to 90 nm or about 70 nm to 90 nm.

The crystalline of the grains of the positive active material can be confirmed by X-ray diffraction (XRD), and a unique diffraction peak may appear in the XRD spectrum.

For example, the XRD spectrum of a grain of the positive active material may have diffraction peaks corresponding to the (003) plane and the (110) plane. In addition, it may have (006) plane, (101) plane, (102) plane, (104) plane, (015) plane, (017) plane, (018) plane and/or (113) plane. Among these, the diffraction peak corresponding to the (003) plane may be the main peak.

The diffraction peak of the XRD spectrum of the grains of this positive active material may have a predetermined full width at half maximum (FWHM). The full width at half maximum (FWHM) of the diffraction peak can represent the crystalline of the grain with the corresponding crystal face. The full width at half maximum (FWHM) of each diffraction peak can be adjusted depending on process conditions. For example, in the sintering stage of positive active material precursor and lithium raw material, it may be determined according to heat treatment temperature, heat treatment maintenance temperature, temperature increase speed, temperature decrease speed and/or gas supply condition, etc. It can be decided according to the composite condition of two or more of these.

The present inventor confirmed that the positive active material has good characteristics when the diffraction peak of the grains satisfies the full width at half maximum (FWHM) of a predetermined range. As an example, the ratio of the full width at half maximum (FWHM) of the diffraction peak corresponding to the (110) plane to the full width at half maximum (FWHM) of the diffraction peak corresponding to the (003) plane of the grains of the positive active material (FWHM (110) plane/FWHM (003) plane) can range from 1.30 to 1.60. Within the range it can be 1.35 to 1.50 or 1.35 to 1.45. As another example, the full width at half maximum (FWHM) of the diffraction peak corresponding to the (003) plane of the grains of the positive active material may range from 0.100 to 0.125. Within the range it can be 0.100 to 0.120, 0.105 to 0.120 or 0.105 to 0.115.

As the diffraction peak of the grains of the positive active material satisfies the range, capacity retention can be high and DC resistance increase rate can be low.

Hereinafter, an example of the manufacturing method of the above-described positive active material for all solid batteries will be described.

A manufacturing method of a positive active material for an all solid battery according to an embodiment includes:
forming a positive active material precursor by co-precipitating a solution containing raw materials for a positive active material of a layered crystal structure;
preparing a mixture by mixing the positive active material precursor with a lithium raw material; and
sintering the mixture to form secondary particles formed by agglomeration of the primary particles of the positive active material.

The raw material for forming a positive active material with a layered crystal structure may include nickel (Ni) raw material and cobalt (Co) raw material, and additionally manganese (Mn) raw material or aluminum (Al) raw material. For example, if the positive active material of the layer-type crystal structure is a layer-type nickel-cobalt-manganese-based oxide, the raw material may include nickel (Ni) raw material, cobalt (Co) raw material, and manganese (Mn) raw material. For example, if the positive active material of the layered crystal structure is a layered nickel-cobalt-aluminum oxide, the raw material may include nickel (Ni) raw material, cobalt (Co) raw material, and aluminum (Al) raw material. In addition, the raw material may further include:
zirconium (Zr) raw material, tungsten (W) raw material, magnesium (Mg) raw material, barium (Ba) raw material, calcium (Ca) raw material, titanium (Ti) raw material, tantalum (Ta) raw material, niobium (Nb) raw material, molybdenum (Mo) raw material, silicon (Si) raw material and/or vanadium (V) raw material.

For example, the nickel (Ni) raw material may be nickel acetic acid salt, nickel nitrate, nickel sulfate, nickel halide, nickel hydroxide, hydrate thereof or combination thereof, but is not limited thereto.

For example, cobalt (Co) raw material may be cobalt acetic acid salt, cobalt nitrate, cobalt sulfate, cobalt halide, cobalt hydroxide, hydrate or combination thereof, but is not limited thereto.

For example, the manganese (Mn) raw material may be manganese acetic acid salt, manganese nitrate, manganese sulfate, manganese halide, manganese hydroxide, hydrate or combination thereof, but is not limited thereto.

For example, the aluminum (Al) raw material may be aluminum acetic acid salt, aluminum nitrate, aluminum sulfate, aluminum halide, aluminum hydroxide, hydrate or combination thereof, but is not limited thereto.

A solution containing these raw materials may be an aqueous solution, for example, and each raw material may be mixed in a predetermined ratio considering the composition of the final positive active material. The solution containing the raw materials may further include an organic solvent that can be mixed with water, and the organic solvent may be alcohol such as methanol, ethanol and/or propanol.

The solution containing the raw materials can be co-precipitated within the reactor, and by co-precipitation, nuclei of the positive active material precursor are generated and grown to obtain a positive active material precursor of a predetermined size.

Next, the positive active material precursor obtained above is mixed with a lithium raw material.

The lithium raw material is not particularly limited as long as it is a material that can provide lithium, and may be, for example, LiOH, Li₂CO₃, LiNO₃, CH₃COOLi, or a hydrate or combination thereof.

The positive active material precursor and lithium raw material can be mixed at a mole ratio of 1:9 to 9:1, for example, it can be mixed in a mole ratio of about 2:8 to 8:2, 3:7 to 7:3, 4:6 to 6:4 or 5:5 within the range.

Next, sintering the mixture of the positive active material precursor and lithium raw material obtained above is performed.

Sintering of the mixture can be performed under the condition that the diffraction peak of the grains of the above-described positive active material has a full width at half maximum (FWHM) of a predetermined range. For example, the maximum sintering temperature can be achieved by controlling the predetermined temperature increase and decrease speeds in the 730 to 760° C. temperature range. When sintering, the temperature increase speed and temperature decrease speed can be controlled. For example, the temperature increase speed and temperature decrease speed can each be controlled to less than 5° C. per minute. For example, it can be controlled to below 4° C. per minute or below 3° C. per minute, respectively. The sintering time can be selected from 3 hours to 30 hours, for example.

For example, sintering increases the temperature at a temperature increase rate of 2 to 3° C. per minute. Afterwards, it is maintained at the highest sintering temperature of 730° C. to 755° C. for about 8 to 12 hours. Afterwards, the temperature can be lowered at a cooling speed of 2 to 3° C. per minute.

For example, sintering increases the temperature at a temperature increase rate of 2 to 3° C. per minute. Afterwards, maintain at a temperature of 440 to 460° C. for 3 to 7 hours. Again, increase the temperature at a temperature increase rate of 2 to 3° C. per minute. Afterwards, it is maintained at the highest sintering temperature of 730° C. to 755° C. for about 8 to 12 hours. Lastly, the temperature can be lowered at a temperature cooling speed of 2 to 3° C. per minute.

However, it is not limited to this and can be formed into a positive active material that satisfies the full width at half maximum (FWHM) condition of the above-mentioned diffraction peak by changing various conditions during the sintering stage.

By sintering, a composite material of positive active material precursor and lithium raw material can be obtained. The composite material of the positive active material precursor and lithium raw material may be secondary particles formed by agglomeration of primary particles of the positive active material.

It may further include forming a coating layer on the secondary particle, which is a composite material of this positive active material precursor and lithium raw material. The coating layer can be formed by adding the secondary particles to a solution containing lithium salt and zirconium or niobium salt and reacting. At this time, the reaction may include a heat treatment step, for example, a heat treatment step at a temperature of about 200 to 400° C. for 1 hour to 5 hours.

The positive active material for the above-mentioned all solid battery may be included in the positive electrode of the all solid battery. The positive electrode may be a composite of the solid electrolyte of an all solid battery, and thus the positive electrode may include a solid electrolyte component, for example a sulfide solid electrolyte.

An all solid battery according to one embodiment includes a positive electrode, a negative electrode, and a solid electrolyte interposed between the positive electrode and the negative electrode. Selectively, a positive electrode and a solid electrolyte may be combined to form a positive electrode composite.

A positive electrode (including a positive electrode composite) includes a current collector and a positive active material layer formed on the current collector, and the positive active material layer includes a positive active material for an all solid battery, a conductive material, and a selective binder. In the case of a positive electrode composite, the positive active material layer may further include a solid electrolyte.

The positive active material for all solid batteries is the same as described above. The positive active material for all solid batteries may be included in excess of about 50 wt % relative to the total content of the positive active material layer, within the range of about 55 to 99 wt %, about 60 to 99 wt %, about 65 to 99 wt %, about 70 to 99 wt %, about 75 to 99 wt %, about 55 to 95 wt %, about 60 to 95 wt %, about 65 to 95 wt %, about 70 to 95 wt % or about 75 to 95 wt %.

The conductive material may be a carbon material, for example graphite, carbon black, carbon fluoride, conductive fiber, conductive metal oxide or a combination thereof, but is not limited thereto. The conductive material may be included in an amount of 20 wt % or less relative to the total content of the positive active material layer, for example 0.1 to 20 wt %, 1 to 15 wt % or 1 to 10 wt %.

The binder can improve the binding power of the current collector and positive active material, and the binding power of positive active material and solid electrolyte, and be for example polyvinylidene fluoride polyvinylalcohol, hydroxypropylcellulose, styrene butadiene rubber or combination thereof, but is not limited thereto. The binder may be included in an amount of 30 wt % or less relative to the total content of the positive active material layer, for example about 0.1 to 30 wt %, about 1 to 25 wt % or 1 to 15 wt %.

A solid electrolyte may include, for example, sulfide solid electrolyte. The sulfide solid electrolyte contains lithium (Li) and sulfur(S) as main components and may additionally contain phosphorus (P) and/or halogen (F, CI, Br, I), for example Li₃PS₄, Li₇P₃S₁₁, Li₆PS₅F, Li₆PS₅Br, Li₆PS₅Cl, Li₇P₂S₈I or combination thereof, but is not limited thereto. The solid electrolyte may be included in less than about 50 wt % relative to the total content of the positive active material layer, and may be included in the range of about 5 to 40 wt %, about 10 to 30 wt %, or about 15 to 30 wt %.

The negative electrode includes a current collector and a negative active material layer formed on the current collector. The negative active material layer may include a compound capable of reversible intercalation and deintercalation of lithium and may include, for example, a carbon material such as graphite, a metal compound, metal oxide or a combination thereof.

### DETAILED DESCRIPTION OF THE EMBODIMENTS

Hereinafter, the above-described implementation example will be described in more detail through an exemplary embodiment. However, the exemplary embodiment below is for illustrative purposes only and does not limit the scope.

### Manufacturing of a Positive Active Material for an all Solid Battery

### Preparation Example 1

An aqueous solution containing nickel raw material, cobalt raw material, and manganese raw material was used to form a Ni_{0.8}Co_{0.12}Mn_{0.08}(OH)₂ positive active material precursor by co-precipitation. Next, a mixture was prepared by mixing the positive active material precursor and lithium raw material (LiOH·H₂O) at a mole ratio of 1:1.05. Then, 30 g of the mixture was put into a tube with a diameter of 8 cm, the temperature was raised at a speed of 2.5° C./min, maintained at a maximum sintering temperature of 745° C. for 10 hours, and then the temperature was lowered at a speed of 2.5° C./min. While sintering was in progress, pure O₂ was supplied to maintain the O₂ concentration above 99%, thereby obtaining LiNi_{0.8}Co_{0.12}Mn_{0.08}O₂ positive active material. The average particle size D50 of the positive active material was 4.37 μm.

Li-ethoxide solution was prepared by adding 0.0136 g of lithium metal to 9.03 g of anhydrous ethanol and stirring for more than 30 minutes. Add 0.459 g of propanol solution of 70 wt % zirconium (IV) tetrapropoxide to the prepared Li-ethoxide solution and stir for more than 10 minutes to prepare the coating liquid. Add 15 g of the positive active material obtained above to the prepared coating liquid, stir first at 100 rpm for more than 20 minutes, and secondary stir for more than 10 minutes using an ultrasonic wave disperser.

Next, the solution was evaporated in a water bath at 50° C., using a rotating evaporation concentrate, with an internal pressure of 150 Torr at a speed of 50 rpm. Complete drying was achieved by gradually lowering the atmospheric pressure to 50 torr and 20 torr. Next, the dried powder is subjected to secondary drying in a dry room and room temperature. The secondary dried powder was heated to 300° C. in a sintering furnace and subjected to heat treatment for 2 hours in an oxygen atmosphere to produce a positive active material coated with 1 wt % LiZrO₃.

### Preparation Example 2

Positive active material was obtained using the same method as Preparation Example 1, except that the maximum sintering temperature in the sintering step was changed to 755° C. Here, the average particle size D50 of the positive active material was 4.44 μm.

### Preparation Example 3

The sintering step conditions were changed as follows. Raise the temperature to 450° C. at a speed of 2.5° C./min, maintain at 450° C. for 5 hours, then increase the temperature to 745° C. at a speed of 2.5° C./min, maintain at 745° C. for 10 hours, then lower the temperature at 2.5° C./min

Except for this, positive active material was obtained using the same method as Preparation Example 1. Here, the average particle size D50 of the positive active material was 4.24 μm.

### Exemplary Embodiment 4

Instead of Ni_{0.8}Co_{0.12}Mn_{0.08}(OH)₂ positive active material precursor, Ni_{0.8}Co_{0.1}Mn_{0.1}(OH)₂ positive active material precursor was formed. Additionally, the sintering step was adjusted as follows. Raise the temperature to 450° C. at a speed of 2° C./min, maintain at 450° C. for 5 hours, then increase the temperature to 730° C. at a speed of 2° C./min, maintain at 730° C. for 10 hours, and lower the temperature at a speed of 2.5° C./min

Except for this, positive active material was obtained using the same method as Preparation Example 1. Here, the average particle size D50 of the positive active material was 9.78 μm.

### Comparative Preparation Example 1

The sintering step was adjusted as follows. Raise the temperature to 765° C. at a speed of 2.5° C./min, maintain at 765° C. for 10 hours, and then lower the temperature at a speed of 2.5° C./min. Except for this, positive active material was obtained using the same method as Preparation Example 1. Here, the average particle size D50 of the positive active material was 4.23 μm.

### Comparative Example 2

The sintering step was adjusted as follows. Raise the temperature to 725° C. at a speed of 2.5° C./min, maintain at 725° C. for 10 hours, and then lower the temperature at a speed of 2.5° C./min. Except for this, positive active material was obtained using the same method as Preparation Example 1. Here, the average particle size D50 of the positive active material was 4.67 μm.

### Comparative Preparation Example 3

Instead of Ni_{0.8}Co_{0.12}Mn_{0.08}(OH)₂ positive active material precursor, Ni_{0.8}Co_{0.1}Mn_{0.1}(OH)₂ positive active material precursor was formed. Additionally, the sintering step was adjusted as follows. The temperature was raised to 760° C. at a speed of 2.5° C./min, maintained at 760° C. for 10 hours, and then lowered at a speed of 2.5° C./min to obtain a positive active material with an average particle size of D50 of 10 μm. Except for this, positive active material was obtained using the same method as Preparation Example 1. Here, the average particle size D50 of the positive active material was 9.89 μm.

### Evaluation I

The shape of the positive active material was evaluated according to the Preparation Example and Comparative Preparation Example.

The shape of the positive active material was observed using FE-SEM (JEOP).

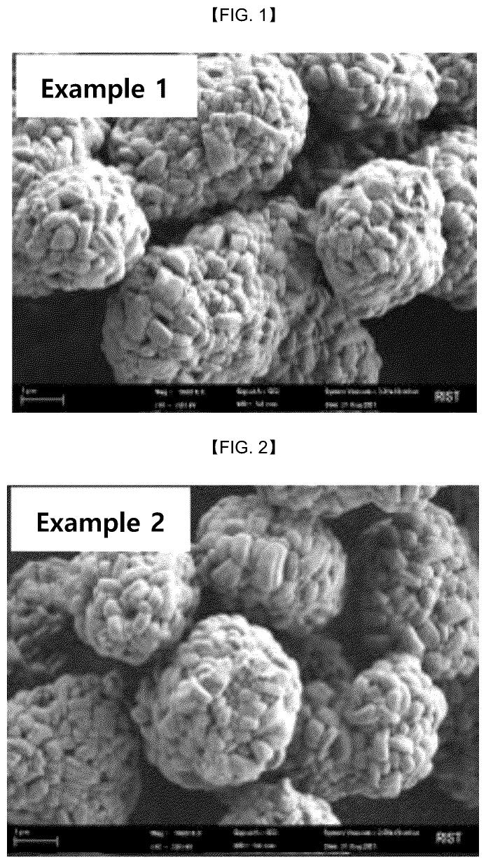

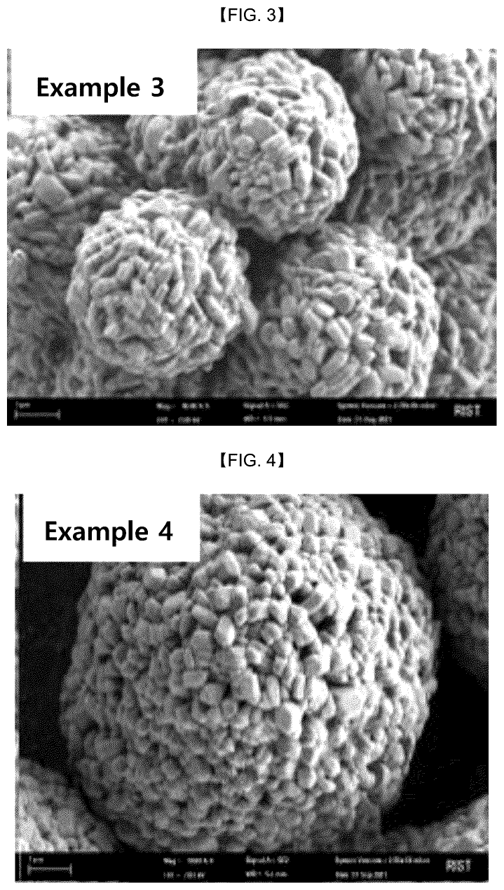

FIGS. 1 to 4 are SEM pictures of positive active material according to Preparation Example 1 to 4.

Referring to FIGS. 1 to 4, it can be seen that the positive active material according to the Preparation Example is formed from secondary particles in which primary particles of actual spherical shape are aggregated.

### Evaluation II

Evaluate the crystal direction of grains of positive active material according to Preparation Example and Comparative Preparation Example.

The crystal direction was determined by measuring theta-2theta diffraction intensity at 10 to 70 degrees using Rigaku Powder XRD equipment. The measured data were fitted with the Pseudo-Voigt function to calculate the full width at half maximum (FWHM) of each crystal plane.

The results are shown in Tables 1 and 2.

TABLE 1

| | exemplary | exemplary | exemplary | exemplary |
|---|---|---|---|---|
| | embodiment | embodiment | embodiment | embodiment |
| | 1 | 2 | 3 | 4 |
| crystal plane | (003) plane, (101) plane, (006) plane, (012) plane, (104) plane, | | | |
| | (015) plane, (017) plane, (018) plane, (110) plane, (113) plane | | | |
| FWHM (003) plane | 0.1095 | 0.1098 | 0.1115 | 0.1053 |
| FWHM ratio | 1.42 | 1.35 | 1.38 | 1.43 |
| (110) plane/(003) plane | | | | |

TABLE 2

| | Comparative | Comparative | Comparative |
|---|---|---|---|
| | Preparation | Preparation | Preparation |
| | Example 1 | Example 2 | Example 3 |
| crystal plane | (003) plane, (101) plane, (006) plane, | | |
| | (012) plane, (104) plane, (015) plane, (017) plane, | | |
| | (018) plane, (110) plane, (113) plane | | |
| FWHM (003) plane | 0.1245 | 0.0994 | 0.1108 |
| FWHM ratio (110) | 1.77 | 1.28 | 1.75 |
| plane/(003)plane | | | |

### Manufacturing of an all Solid Battery

### Exemplary Embodiment 1

A mixed powder was prepared by mixing 68 wt % of positive active material according to Preparation Example 1, 29 wt % of argyrodite solid electrolyte, and 3 wt % of C65 (conductive material) with a solvent containing a small amount of binder dissolved.

Argyrodite solid electrolyte, which functions as a separator, was quantitatively charged to the jig for all solid battery evaluation. Afterwards, after primary pressure was applied with a force of 300 MPa or more to a thickness of 100 μm, 10 mg of the mixed powder was added to one side and secondary pressure was applied to form a positive electrode. Subsequently, Li—In alloy was added to the other side of the solid electrolyte and pressed to produce an all solid battery.

### Exemplary Embodiment 2

An all solid battery was manufactured using the same method as exemplary embodiment 1, except that the positive active material according to Preparation Example 2 was used instead of the positive active material according to Preparation Example 1.

### Exemplary Embodiment 3

An all solid battery was manufactured using the same method as exemplary embodiment 1, except that the positive active material according to Preparation Example 3 was used instead of the positive active material according to Preparation Example 1.

### Exemplary Embodiment 4

An all solid battery was manufactured using the same method as exemplary embodiment 1, except that the positive active material according to Preparation Example 4 was used instead of the positive active material according to Preparation Example 1.

### Comparative Example 1

An all solid battery was manufactured using the same method as exemplary embodiment 1, except that the positive active material according to Comparative Preparation Example 1 was used instead of the positive active material according to Preparation Example 1.

### Comparative Example 2

An all solid battery was manufactured using the same method as exemplary embodiment 1, except that the positive active material according to comparison Preparation Example 2 was used instead of the positive active material according to Preparation Example 1.

### Comparative Example 3

An all solid battery was manufactured using the same method as exemplary embodiment 1, except that the positive active material according to comparison Preparation Example 3 was used instead of the positive active material according to Preparation Example 1.

### Evaluation III

All solid batteries according to the exemplary embodiment and Comparative Example were installed in the charge and discharge machine, and the charge and discharge characteristics were evaluated at 30 degrees. The method of charge and discharge was performed using the constant current-voltage method with a current density of 0.1C. The charge terminal voltage was set to 3.7V, and the charge end current was set to a current of 0.02C. During discharge, the discharge was performed using the 0.1C constant current method, and the end discharge voltage was set to 1.9V. After repeating the same protocol one additional time, cycle evaluation was performed by increasing the current density to 0.5C to evaluate the battery lifespan characteristic. When charging with the 0.5C constant current-voltage method, the charge terminal voltage was set to 3.7V, and the charge end current was set to 0.1C. The pause time between charge and discharge of each cycle was set to 20 minutes. The DC-iR value was calculated by dividing the difference between the open circuit voltage (OCV) after 20 minutes of rest after completion of 3.7V constant current-voltage charge and the drop voltage at the time of completion of discharge initial current application by the applied current.

The results are shown in Table 3.

TABLE 3

| | | | Increasing ratio |
|---|---|---|---|
| | Charge capacity | Retention ratio (%) | pf DC-IR (%) |
| | (mAh/g), 0.1 C | 45° C., 30 cycle | 45° C., 30 cycle |
| Exemplary | 218.7 | 96.0 | 46.7 |
| embodiment 1 | | | |
| Exemplary | 212.7 | 96.8 | 45.9 |
| embodiment 2 | | | |
| Exemplary | 221.0 | 95.5 | 44.8 |
| embodiment 3 | | | |
| Exemplary | 227.8 | 98.5 | 38.3 |
| embodiment 4 | | | |
| Comparative | 209.1 | 80.3 | 80.5 |
| Example 1 | | | |
| Comparative | 215.8 | 87.5 | 78.9 |
| Example 2 | | | |
| Comparative | 222.2 | 70.6 | 140.9 |
| Example 3 | | | |

Referring to Table 3, it can be seen that the all solid battery according to the exemplary embodiment has a high capacity maintenance rate and a low DC resistance increase rate compared to the all solid battery according to the Comparative Example.

Although exemplary embodiments have been described in detail above, the scope is not limited to this, and various modifications and improvements of a person of an ordinary skill in the art using the basic concept defined in the following claim range also fall within the scope.

1. A positive active material for all solid batteries, comprising:
a positive active material with layered crystal structure, and
wherein, a XRD spectrum of a grain of the positive active material has diffraction peaks corresponding to the (003) plane and the (110) plane, and
a ratio of the full width at half maximum (FWHM) of the diffraction peak corresponding to the (110) plane to the full width at half maximum (FWHM) of the diffraction peak corresponding to the (003) plane is 1.30 to 1.60.

2. The positive active material of claim 1, wherein:
the full width at half maximum (FWHM) of the diffraction peak corresponding to the (003) plane is 0.100 to 0.125.

3. The positive active material of claim 1, wherein:
the positive active material is a secondary particle formed by agglomeration of primary particles,
an average particle diameter D50 of the secondary particle is 3 μm to 12 μm.

4. The positive active material of claim 1, wherein:
an average grain size of the positive active material is 70 nm to 90 nm.

5. The positive active material of claim 1, wherein:
the positive active material comprises nickel (Ni) and cobalt (Co).

6. The positive active material of claim 5, wherein:
the positive active material comprises layered nickel-cobalt-manganese-based oxide or layered nickel-cobalt-aluminum-based oxide.

7. The positive active material of claim 1, wherein:
the positive active material comprises a coating layer containing LiZrO₃ or LiNbO₃.

8. The positive active material of claim 7, wherein:
the LiZrO₃ or LiNbO₃ is included at 0.1 to 1.5 wt % for the positive active material.

9. A positive electrode, comprising:
the positive active material for all solid battery according to claim 1.

10. The positive electrode of claim 9, further comprising:
a sulfide solid electrolyte.

11. An all solid battery comprising the positive electrode according to claim 10.

12. The all solid battery of claim 11, further comprising:
a negative electrode and a sulfide solid electrolyte.
